(19) United States
(12) Patent Application Publication
(10) Pub. No.: US 2025/0350923 A1
(43) Pub. Date: Nov. 13, 2025

(54) Communication System and Method for Providing a Communication Function

(71) Applicant: Bayerische Motoren Werke Aktiengesellschaft, Muenchen (DE)

(72) Inventor: Michael NEUHAEUSER, Sankt Wolfgang (DE)

(21) Appl. No.: 19/203,476

(22) Filed: May 9, 2025

(30) Foreign Application Priority Data
May 13, 2024 (DE) 10 2024 113 249.3

(51) Int. Cl. H04W 8/18; H04W 4/12; H04W 76/15

(52) U.S. Cl. CPC H04W 8/183; H04W 4/12; H04W 76/15

(57) ABSTRACT

A communication system includes a first slot set up for a plurality of first forms of communication using a communication profile assigned to the first slot, and a second slot set up for a plurality of second forms of communication using a communication profile assigned to the second slot. A configuration module is set up to variably assign a respective communication profile for a communication to the first slot and the second slot based on at least one assignment criterion. The at least one assignment criterion relates to at least one form of communication of the plurality of first forms of communication and/or plurality of second forms of communication. A communication module carries out communication via the first slot or the second slot using the communication profile assigned by the configuration module.

### CROSS REFERENCE TO RELATED APPLICATION

This application claims priority under 35 U.S.C. § 119 from German Patent Application No. 10 2024 113 249.3, filed May 13, 2024, the entire disclosure of which is herein expressly incorporated by reference.

### BACKGROUND AND SUMMARY

The present disclosure relates to a communication system, a means of transportation with such a communication system, a computer-implemented method for providing a communication function and a storage medium for executing the method. The present disclosure relates in particular to a demand-based assignment of eSIM profiles to slots, such as to a main slot and secondary slot of a dual SIM technology.

In modern vehicles today, a plurality of communication profiles is often available to enable vehicle-based services, user-specific communication, etc. The use of multiple communication profiles can lead to conflicts, especially if both communication profiles cannot be used simultaneously. For example, an incoming call on one of the communication profiles can interrupt the data connectivity of the other communication profile, as the latter is degraded or suspended by the incoming call. This can lead to interruptions in vehicle-based services, for example, which in turn leads to user dissatisfaction.

It is an object of the present disclosure to indicate a communication system, a means of transportation with such a communication system, a computer-implemented method for providing a communication function and a storage medium for executing the method, which can ensure a communication capacity of various forms of communication. In particular, it is an object of the present disclosure to avoid an interruption of communication in the case of a plurality of slots, e.g., in a modem.

In at least one embodiment, a communication system, in particular for a means of transportation, is indicated. The communication system comprises a first slot (also referred to as “main slot”), which is set up for a plurality of first forms of communication using a (first) communication profile assigned to the first slot; a second slot (also referred to as “secondary slot”), which is set up for a plurality of second forms of communication using a (second) communication profile assigned to the second slot; a configuration module which is set up to variably assign a respective communication profile for a communication to the first slot and the second slot based on at least one assignment criterion, wherein the at least one assignment criterion relates to an availability of at least one form of communication of the plurality of first forms of communication and/or plurality of second forms of communication; and a communication module which is set up to carry out communication via the first slot or the second slot with the communication profile assigned by the configuration module.

In at least one embodiment, the communication profiles may be flexibly assigned during operation to two slots with different capabilities, so that the availability of forms of communication or services such as telephony, messaging and data connectivity can be specifically ensured. For example, both slots can be set up for telephony, but only one of the two slots for data connectivity. If a communication profile now receives a call in the slot without data connectivity and processes this, a communication profile in the slot degrades with data connectivity, so that the data connectivity is interrupted (e.g. in the case of Dual-SIM Dual Standby, DSDS). The communication system can now change or swap the assignment of the communication profiles to the slots when the call is received, so that the communication profile that receives the call is assigned to the slot with data connectivity and the data connectivity is retained. As a result, in this example, both desired services, namely telephony and data connectivity can be provided simultaneously. The embodiments of the present disclosure can thus enable the user to be provided with forms of communication or services whenever they are needed.

The configuration module and the communication module can comprise software components/algorithms that are configured to be executed on at least one processor and thereby perform the functionalities of the respective module.

The configuration module and the communication module can be implemented in a combined software and/or hardware module. Alternatively, the configuration module and the communication module can each be implemented in separate software and/or hardware modules.

The embodiments of the present disclosure are described with reference to a first slot and a second slot. However, the present disclosure is not limited to two slots and there may be a number n with n>2 slots, which can be implemented in embodiments of the present disclosure. For example, the communication system can comprise a main slot and plurality of secondary slots.

The term “slot”, as used in the present disclosure, refers to a (e.g. software-based) module which is (permanently) configured or enabled for certain forms of communication or services such as telephony, messaging, and data connectivity, and assigned to the communication profile to establish network connections. In traditional systems, slots are the physical slots into which SIM cards are inserted to establish network connections. In the present disclosure, the slots can be software-based “plug-in locations” to which e.g. eSIM profiles are assigned. However, the present disclosure is not limited to software-based “plug-in locations” and in other embodiments it may involve SIM cards inserted into physical plug-in locations which are then “swapped” (or assigned) by software.

Preferably, the first slot is a DDS (Dedicated Data Subscription) slot. DDS means that the communication profile assigned to the first slot (“main slot”) is used for data connections.

Preferably, the second slot is a NDDS (Non-Dedicated Data Subscription) slot. NDDS means that the communication profile assigned to the second slot (“secondary slot”) is not used for data connections.

Preferably, the communication system is set up for Dual-SIM Dual Standby, DSDS. In the case of DSDS both communication profiles are permanently available as long as no calls are being made. As soon as a call is made via a communication profile, the other communication profile is temporarily unavailable for the duration of the call; it goes into standby mode, i.e. the communication profile is downgraded or suspended.

Preferably, the plurality of first forms of communication, for which the first slot is enabled, is selected from the group, which comprises or consists of telephony (or voice calls e.g. via a telephone tariff), messaging (e.g. SM S) and data connectivity (or data usage e.g. via a data tariff), or consists of this.

Additionally, or alternatively, the plurality of second forms of communication, for which the second slot is enabled, selected from the group, which comprise or consist of telephony (or voice calls e.g. via a telephone tariff), messaging (e.g. SMS) and data connectivity (or data usage e.g. via a data tariff).

Preferably, the plurality of first forms of communication, for which the first slot is enabled, and the plurality of second forms of communication, for which the second slot is enabled, differ at least in part. For example, the plurality of first forms of communication may comprise or be telephony, messaging and data connectivity, and the plurality of second forms of communication may comprise or be telephony and messaging (i.e. no data connectivity).

Preferably, a number of the plurality of first forms of communication is greater than a number of the plurality of second forms of communication. For example, the plurality of first forms of communication may be three forms of communication (e.g. telephony, messaging, and data connectivity), and the plurality of second forms of communication may be two forms of communication (e.g. telephony and messaging).

Preferably, one communication profile (e.g. the communication profile in the first slot) degrades when the other communication profile (e.g. the communication profile in the second slot) receives and handles a call. In the degraded or suspended state, the communication profile is still logically, but no longer physically, registered in the network, and the services of the degraded or suspended communication profile are no longer available.

The configuration module is set up to variably assign a respective communication profile for a communication to the first slot and the second slot based on at least one assignment criterion, wherein the at least one assignment criterion relates to an availability of at least one form of communication of the plurality of first forms of communication and/or plurality of second forms of communication.

Preferably, the at least one form of communication relates to data connectivity. In other words, availability can affect data connectivity, for example by ensuring that data connectivity is maintained and not interrupted, e.g., by degrading a communication profile.

In some embodiments, the configuration module can be configured to assign the communication profile for communication in such a way that data connectivity is possible and/or maintained during a call. In other words, it can be ensured that data connectivity is maintained and is not interrupted, for example, by degrading a communication profile when a call is received.

The term “communication profile”, as it is used in the context of the present disclosure, includes in particular SIM profiles but also other current and future communication profiles that enable a communication function.

A respective communication profile is assigned to each of the two slots, wherein the assignment can be changed or swapped during operation. For example, a first communication profile can be assigned to the first slot, and a second communication profile can be assigned to the second slot. This assignment can be changed or swapped by assigning the second communication profile to the first slot and the first communication profile to the second slot.

Preferably, the first communication profile is a first SIM (subscriber identity module) profile, in particular a first eSIM (embedded subscriber identity module) profile. Additionally or alternatively, the second communication profile can be a second SIM profile, in particular a second eSIM profile.

An eSIM is a virtualized SIM card profile which is installed on a eUICC chip permanently assembled in a device. As soon as an eSIM-Profil is installed on a eU ICC, it works just like a physical SIM card, including a unique ICCID and an authentication key for the network generated by a communication service provider.

The communication service provider can be a manufacturer, administrator etc. of the communication profile, and can in particular be a network operator of a mobile network (mobile radio company or Mobile Network Operator (MNO)). The communication service provider can, for example, enable communication in a mobile network according to the LTE (Long-Term Evolution) standard and/or the 5G standard.

Preferably, one communication profile of the first and second communication profiles is a global SIM or eSIM, and the other communication profile of the first and second communication profiles is a user-specific SIM or eSIM. The global SIM or eSIM can differ from a user-specific SIM or eSIM in that the global SIM or eSIM does not have a local IP and/or has greater latencies and/or does not correspond to KY C (know your customer). The global SIM or eSIM can be assigned to the vehicle and/or a vehicle manufacturer for example, whereas the user-specific SIM or eSIM can be assigned to the user.

Preferably, the communication system comprises or is a modem. The communication can take place using the selected slots and the communication profile assigned to each slot. In particular, the modem can be a single modem, so that both communication profiles cannot be used simultaneously. However, the variable assignment of the communication profile to the slots of the modem in accordance with the invention can ensure that the user is provided with forms of communication or services whenever they are needed.

According to a further aspect of the present disclosure, a means of transportation, in particular a vehicle, is provided. The means of transportation comprises the communication system in accordance with the embodiments of the present disclosure.

The means of transportation can be a vehicle (e.g., a motor vehicle), a ship, or an aircraft (e.g., a drone for passenger transport), but is not limited to these examples. For instance, the means of transportation may also include a shoe or other wearable device (e.g., wearables, clothing, etc.). The term vehicle encompasses cars, trucks, buses, motorhomes, motorcycles, etc., which are used to transport people, goods, etc. In particular, the term includes motor vehicles for passenger transportation.

According to a further aspect of the present disclosure, a computer-implemented method for providing a communication function, in particular for a means of transportation, is provided. The method comprises assigning, based on at least one assignment criterion, a first communication profile to a first slot and a second communication profile to a second slot, wherein the first slot is set up for a plurality of first forms of communication and the second slot for a plurality of second forms of communication, and wherein the at least one assignment criterion relates to an availability of at least one form of communication of the plurality of first forms of communication and/or plurality of second forms of communication; and carrying out the communication via the first slot or the second slot with the assigned communication profile.

The method for providing a communication function can implement the aspects of the communication system described herein.

According to a further aspect of the present disclosure, a software (SW) program is indicated. The SW program can be set up to be executed on one or a plurality of processors, and thereby to execute the method for providing a communication function described in this document.

According to a further aspect of the present disclosure, a non-transitory storage medium is indicated. The storage medium can comprise a SW program, which is set up to be executed on one or a plurality of processors, and thereby to carry out the method for providing a communication function described in this document.

According to a further aspect of the present disclosure, software with a program code is indicated. The software is set up for carrying out the method for providing a communication function when the software runs on one or plurality of devices.

According to a further aspect of the present disclosure, a communication system is disclosed. The communication system comprises one or more processors and at least one storage device coupled to the processors, containing instructions that can be executed by the processors to perform the method for providing a communication function as described in this document.

A processor or processor module is a programmable arithmetic unit, i.e. a machine or an electronic circuit that controls other elements according to commands given and thereby drives an algorithm (process).

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a vehicle with a communication system according to embodiments of the present disclosure,

FIGS. 2A and 2B schematically show a demand-based assignment of communication profiles to slots according to embodiments of the present disclosure, and

FIG. 3 shows a flowchart of a method for providing a communication function according to embodiments of the present disclosure.

### DETAILED DESCRIPTION OF THE DRAWINGS

In the following, unless otherwise stated, the same reference signs are used for identical or similarly acting elements.

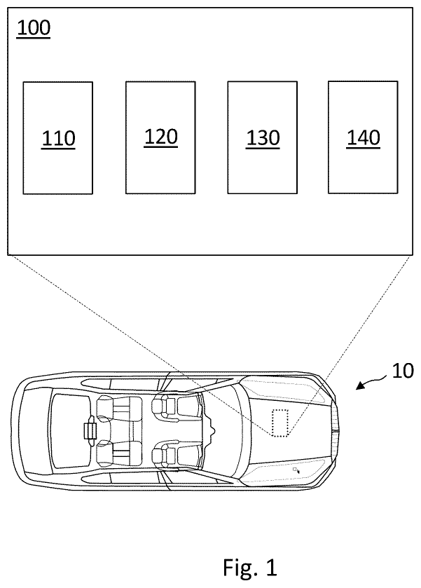

FIG. 1 schematically shows a vehicle 10 with a communication system 100 for providing a communication function according to embodiments of the present disclosure.

In the example shown in FIG. 1, the communication system 100 is integrated into the vehicle 10. However, the present disclosure is not limited to this and the communication system 100 can also be present, for example, in a mobile terminal or other portable utensil (e.g. wearables, items of clothing, etc.). The term “mobile device” includes in particular smartphones, but also other mobile telephones or cell phones, personal digital assistants (PDAs), tablet PCs and all current and future electronic devices which are equipped with communication technology.

The communication system 100 comprises a first slot 110, which is set up for a plurality of first forms of communication using a communication profile assigned to the first slot 110; a second slot 120, which is set up for a plurality of second forms of communication using a communication profile assigned to the second slots 120; a configuration module 130, set up, to variably assign a respective communication profile for a communication to the first slot 110 and the second slot 120, based on at least one assignment criterion, wherein the at least one assignment criterion relates to an availability of at least one form of communication of the plurality of first forms of communication and/or plurality of second forms of communication; and a communication module 140, which is set up to carry out communication via the first slot 110 or the second slot 120 with the communication profile assigned by the configuration module.

This allows a flexible assignment of the communication profiles to the slots 110, 120 during operation, so that the availability of forms of communication or services can be specifically ensured. The communication profiles can be eSIM profiles, the present disclosure is but is not limited to this.

The forms of communication can comprise telephony (or voice calls e.g. via the telephone tariff), messaging (e.g. SM S) and/or data connectivity (or data usage e.g. via a data tariff), but are not limited to this.

In some embodiments, the plurality of first forms of communication and the plurality of second forms of communication differ at least partly. For example, the plurality of first forms of communication, for which the first slot 110 is enabled, comprise telephony, messaging and data connectivity, and the plurality of second forms of communication, for which the second slot 120 is enabled, comprise telephony and messaging but not data connectivity.

In some embodiments, the communication system can be configured for Dual-SIM Dual Standby (DSDS). In the case of DSDS, both communication profiles are continuously available in both slots 110 and 120, as long as no call is being made. As soon as a call is made via a communication profile, the other communication profile is temporarily unavailable for the duration of the calls; it goes into the Standby mode, i.e. the communication profile is degraded or suspended. The configuration module 130 can be set up to change the assignment of the communication profiles to the slots 110, 120 in such a way that data connectivity is possible and/or is maintained during a call. In other words, it can be ensured that data connectivity is maintained and not interrupted, for example, by a degradation of a communication profile when a call is received on another communication profile.

In some embodiments, the communication module 140 comprises or is a modem. In particular, the modem can be a single modem, allowing both communication profiles A and B to be used simultaneously without restriction. However, the flexible assignment of the communication profiles to the slots 110 and 120, in accordance with the invention, ensures that the user is provided with communication forms or services whenever needed.

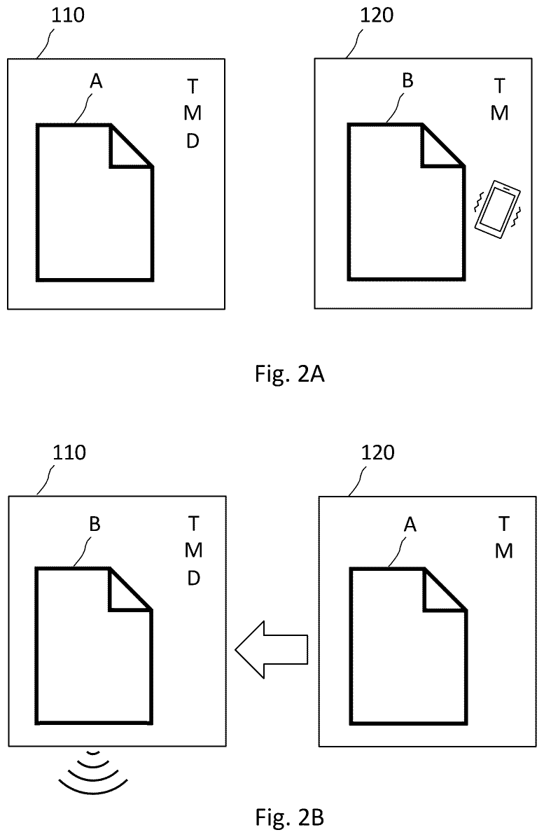

FIGS. 2A and 2B schematically show a demand-based assignment of communication profiles A, B according to embodiments of the present disclosure.

The first communication profile A can be a first eSIM profile, and the second communication profile B can be a second eSIM profile.

In the examples shown in FIGS. 2A and 2B, the forms of communication for the first slot 110 include telephony (T), messaging (M), and data connectivity (D). The forms of communication for the second slot 120 include telephony (T) and messaging (M), but exclude data connectivity.

The first communication profile A in the first slot 110 can degrade if the second communication profile B in the second slot 120 receives and handles a call. In the degraded or suspended state, the first communication profile A remains logically registered in the network but is no longer physically registered, and the services of the degraded or suspended first communication profile A are no longer available.

Assuming the first communication profile A or the first slot 110 is currently selected for the communication and data communication is carried out e.g. in the context of a Cloud-based navigation or an entertainment streaming via the data connectivity D of the first slots 110 and the corresponding first communication profile A. If the second communication profile B receives a call in this state as is shown in FIG. 2A, the assignment of the communication profiles A, B to the slots 110, 120 can be swapped so that data connectivity D is received and now is carried out via the second communication profile B in the first slot 110.

The present disclosure is not limited to this example, however, and numerous other use cases are conceivable. For example, the second communication profile B or the second slot 120 can currently be selected for communication and entertainment streaming is now to be started. The assignment of the communication profiles A and B to the slots 110, 120 can then be swapped to enable data connectivity D for streaming using the second communication profile B.

In some embodiments one of the communication profiles (e.g. the first communication profile A) can be a global SIM or eSIM, and the other communication profile (e.g. the second communication profile B) can be a user-specific SIM or eSIM.

The global SIM or eSIM can differ from a user-specific SIM or eSIM in that the global SIM or eSIM has no local IP and/or greater latencies and/or does not correspond to KY C (know your customer). The global SIM or eSIM can be assigned to the vehicle and/or a vehicle manufacturer for example, whereas the user-specific SIM or eSIM can be assigned to the user.

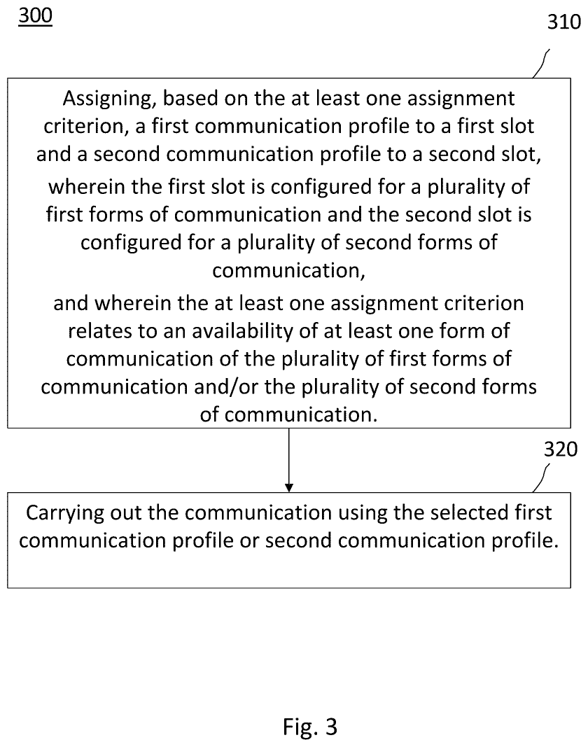

FIG. 3 schematically shows a flowchart of a method 300 for providing a communication function according to embodiments of the present disclosure. The method 300 can be implemented through corresponding software that is executable by one or more processors (e.g., a CPU).

The method 300 comprises, in the block 310, assigning, a first communication profile to a first slot and a second communication profile to a second slot, based on at least one assignment criterion, wherein the first slot is set up for a plurality of first forms of communication and the second slot for a plurality of second forms of communication, and wherein the at least one assignment criterion relates to an availability of at least one form of communication of the plurality of first forms of communication and/or plurality of second forms of communication; and in the block 320 carrying out the communication via the first slot or the second slot with the corresponding communication profile.

According to the invention, the communication profiles are flexibly assigned to two slots with different capabilities during operation, so that the availability of forms of communication or services such as telephony, messaging and data connectivity can be specifically ensured. For example, both slots can be set up for telephony, but only one of the two slots for data connectivity. If a communication profile in the slot without data connectivity receives a call and processes it, a communication profile in the slot with data connectivity is degraded so that the data connectivity is interrupted (e.g. in the case of dual SIM dual standby, DSDS). The communication system can now change or swap the assignment of the communication profiles to the slots when the call is received, so that the communication profile that receives the call is assigned to the slot with data connectivity and the data connectivity is maintained. As a result, both desired services, namely telephony and data connectivity, can be provided simultaneously in this example. The embodiments of the present disclosure can therefore ensure that the user is provided with forms of communication or services whenever they are needed.

Although the invention has been illustrated and explained in detail by preferred embodiments, the invention is not limited by the disclosed examples and other variations may be derived by the person skilled in the art without departing from the scope of protection of the invention. It is therefore clear that a plurality of possible variations exists. It is also clear that embodiments mentioned by way of example really only represent examples which are not to be understood in any way as limiting, for example, the scope of protection, the possible applications, or the configuration of the invention. Rather, the preceding description and the description of the figures enable the person skilled in the art to implement the exemplary embodiments in concrete terms, wherein the person skilled in the art, being aware of the disclosed inventive concept, can make various modifications, for example with regard to the function or the arrangement of individual elements mentioned in an exemplary embodiment, without leaving the scope of protection defined by the claims and their legal equivalents, such as further explanations in the description.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A communication system, comprising:
a first slot configured for a plurality of first forms of communication using a communication profile assigned to the first slot;
a second slot configured for a plurality of second forms of communication using a communication profile assigned to the second slot;
a configuration module configured to variably assign a respective communication profile for a communication to the first slot and the second slot based on at least one assignment criterion, wherein the at least one assignment criterion relates to an availability of at least one form of communication of the plurality of first forms of communication and/or plurality of the second forms of communication; and
a communication module configured to carry out communication using the communication profile assigned by the configuration module through either the first slot or the second slot.

2. The communication system of claim 1, wherein:
the plurality of first forms of communication comprises telephony, messaging and data connectivity; and/or
the plurality of second forms of communication comprises telephony and messaging.

3. The communication system of claim 1, wherein a number of the plurality of first forms of communication is greater than a number of the plurality of second forms of communication.

4. The communication system of claim 1, wherein the communication system is set up for Dual-SIM Dual Standby.

5. The communication system of claim 1,
wherein the availability of the at least one form of communication relates to an availability of data connectivity, and
wherein the configuration module is set up to assign the communication profile for the communication is such a way that data connectivity is possible and/or is maintained during a call.

6. The communication system of claim 1, wherein the communication profiles are SIM profiles.

7. The communication system of claim 1,
wherein the communication module comprises or is a modem, and
wherein the communication is carried out via the modem.

8. A vehicle comprising the communication system of claim 1.

9. A computer-implemented method for providing a communication function, comprising:
assigning a first communication profile to a first slot and a second communication profile to a second slot based on at least one assignment criterion, wherein the first slot is configured for a plurality of first forms of communication and the second slot is configured for a plurality of second forms of communication, and wherein the at least one assignment criterion relates to an availability of at least one form of communication of the plurality of first forms of communication and/or plurality of second forms of communication; and
carrying out the communication via the first slot or the second slot using the assigned communication profile.

10. A non-transitory storage medium storing instructions that when executed by a computing device cause performance of the method of claim 9.
